(19) United States
(12) Patent Application Publication
(10) Pub. No.: US 2008/0059019 A1
(43) Pub. Date: Mar. 6, 2008

(54) METHOD AND SYSTEM FOR ON-BOARD AUTOMOTIVE AUDIO RECORDER

(75) Inventors: David J. Delia, LaGrangeville, NY (US); Wayne M. Delia, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES COPORATION, Armonk, NY (US)

(21) Appl. No.: 11/468,066

(22) Filed: Aug. 29, 2006

(51) Int. Cl. G06F 19/00

(52) U.S. Cl. 701/35; 701/29; 340/438

(57) ABSTRACT

A recording system coupled to an on-board diagnostic system is provided. The recording system includes at least one sensor device for detecting signals undetected by the on-board diagnostic system; a recording device module for generating and storing audio data associated with the undetected signals; and a processor coupled to the recording device module. In one embodiment, the processor is configured for executing application software for integrating the audio data into the on-board diagnostic system. The recording system further includes time stamping circuitry operably connected to the recording device module for associating a time code with the undetected signals for generating a time-stamped electrical data signals.

### BACKGROUND OF THE INVENTION

1. Technical Field

The present disclosure relates generally to on-board diagnostic systems used in automotive applications for providing a vehicle with self-diagnostic capabilities. In particular, the present disclosure relates to a method and system for on-board automotive audio recorder.

2. Description of Related Art

OBD-II systems (On-Board Diagnostics System, Generation 2) provide for diagnostic and reporting capability of a plurality of engine control and emission system malfunction. A serial data stream consisting of a plurality of basic data parameters and diagnostic trouble codes is generated as part of the diagnostic system. In particular, OBD-II systems provide for improved in-use emissions compliance of an automobile by alerting the vehicle operator when a malfunction exists and aiding repair technicians in identifying and repairing malfunctioning circuits in the emission control system. For example, when a malfunction is detected, the OBD-II system provide for a diagnostic trouble code (DTC) and fault isolation logic charts corresponding to the malfunction for storing in the vehicle's internal computer and for assisting technicians in determining the likely cause of the engine control and emissions system malfunctions. In addition to generating a DTC, a malfunction indicator light (MIL) or check engine light may also be illuminated upon detection of the malfunction.

Modem OBD-II systems are applied to systems which are considered most likely to cause a significant increase in exhaust emission if a malfunction occurs, such as for example, all major engine sensors, the fuel metering system, exhaust gas recirculation function. However, although a variety of malfunctions are identified, this method of diagnostic data capture and analysis often provides insufficient information to convey a particular mechanical problem. For example, the symptoms of intermittent problems often cannot be duplicated or recreated during a diagnostic test drive. In addition, many subsystems of the vehicle are not connected to the OBD-II data collection system for identifying malfunctions and transmitting information regarding the malfunction to the OBD-II system. Consequently, such information is not stored as part of the DTC. Moreover, vibratory and acoustic sounds are also not captured and thus many audible mechanical vibrations are generally not exploited as part of a failure analysis.

To overcome the drawbacks in the prior art, it is an aspect of the present disclosure to provide a method and system for on-board automotive audio recorder for collecting and storing audio data related to vibratory and acoustic mechanical sounds. The audio data is then integrated into the on-board diagnostic system of a vehicle.

### SUMMARY OF THE INVENTION

The present disclosure is directed to a method and system for on-board automotive audio recorder. In one embodiment, a recording system is described coupled to an on-board diagnostic system for enhancing on-board diagnostics of intermittent and/or mechanical automotive problems. The system includes at least one sensor device for detecting at least one of a vibratory and acoustic signals, wherein the at least one of a vibratory and acoustic signals are undetected by said on-board diagnostic system; a recording device module for generating and storing an audio data associated with the undetected signals; and at least one processor coupled to the recording device module, wherein the at least one processor is configured for executing application software for integrating the audio data into the on-board diagnostic system. The recording system further includes time stamping circuitry operably connected to the recording device module and being configured for associating a time code with the undetected signals for generating at least one time-stamped data signals. Moreover, the recording system includes an activation control panel coupled to the recording device module for effecting actuation of the recording device module. In one embodiment, the activation control panel is adapted for receiving operator input, the operator input being associated with the undetected signals. Furthermore, the at least one processor may include a notification module for generating and transmitting a notification message to an operator, where the notification message may be in the form of an indicator lights, audible beep, instant message or a combination thereof.

The at least one sensor device is selectively in proximity to a vehicle component. In one embodiment, the vehicle component may include an engine compartment, passenger compartment, trunk compartment, or a combination thereof. Moreover, the at least one sensor device may be an acoustic vibration pick-up device. Alternatively, the at least one sensor device may be an acoustic sensors, electromagnetic sensors, mechanical sensors, chemical sensors, thermal sensors, optical sensors and radiation sensors or a combination thereof.

In yet another embodiment a system is described having at least one sensor device for sensing at least one signal undetected by an on-board diagnostic system; a recording device module having time stamping circuitry for associating a time code with the undetected signal for generating time-stamped data signals, wherein the recording device module is configured for recording the time-stamped data signals; and at least one processor interfaced to the recording device module, wherein the at least one processor is configured for executing application software for integrating the data file into the on-board diagnostic system. The at least one sensor device is an acoustic vibration pick-up device. In addition, the at least one signal includes at least one of a vibratory and acoustic signal. Further still, the at least one signal include an electrical signal associated with a vehicle component. The system further includes an activation control panel coupled to the recording device module for effecting actuation of the recording device module. The activation control panel is adapted for receiving operator input and further wherein the operator input is associated with the undetected signals.

A method for integrating signals into an on-board diagnostic system is also described. In one embodiment, the method includes detecting signals undetected by the on-board diagnostic system; recording the undetected signals; and integrating the recorded signals into the on-board diagnostic system. The method further includes generating a time code associated with the recorded signals for time stamping the recorded signals. The undetected signals are associated with at least one of a vibratory and acoustic sound.

In another embodiment, a method for integrating audio data into an on-board diagnostic system is described. In this particular embodiment, the method includes generating and transmitting signals associated with vibratory and acoustic sounds, wherein the signals are undetected by the on-board diagnostic system; time stamping the signals for associating a time code with the signals; generating and recording an audio data associated with the time-stamped signals; and transferring the audio data into a serial data stream of the on-board diagnostic system. The method further includes receiving operator input, wherein the operator input is associated with the undetected signals. In addition, the method further includes combining data stream associated with the on-board diagnostic system and the digitized audio data for diagnostic display.

Other features of the presently disclosed method and system for on-board automotive audio recorder will become apparent from the following detail description taken in conjunction with the accompanying drawing, which illustrate, by way of example, the presently disclosed method and system.

### BRIEF DESCRIPTION OF THE DRAWINGS

The features of the presently disclosed method and system for on-board automotive audio recorder will be described hereinbelow with references to the figures, wherein:

FIG. 1 is an environmental perspective view illustrating an automobile having an exemplary on-board automotive audio recorder system mounted thereto, according to one embodiment of the present disclosure;

FIG. 2 is a schematic illustration of an exemplary on-board automotive audio recorder system and corresponding modules, in accordance with the present disclosure;

FIG. 3 is an exemplary electrical circuit diagram of the on-board automotive recorder system of FIG. 2;

FIG. 4 is a flow chart illustrating a method for integrating audio data with an on-board diagnostic system, in accordance with the present disclosure.

### DETAILED DESCRIPTION

Referring now to the drawing figures, wherein like references numerals identify identical or corresponding elements, an embodiment of the presently disclosed method and system for on-board automotive audio recorder will now be disclosed in detail. The on-board automotive audio recorder system of the present disclosure provides for diagnostic audio data digitally recorded for providing complementary parametric data to an OBD-II system (On-Board Diagnostics System, Generation 2) of a vehicle.

The on-board automotive audio recorder system includes a plurality of sensor devices for detecting and recording signals undetected by the OBD-II system and transferring and implementing the undetected signals into the serial data stream of the OBD-II system. In particular, the on-board automotive audio recorder is used for integrating at least one of a vibratory and acoustic sounds associated with intermittent and mechanical sounds into the OBD-II system. A plurality of sensor or acoustic vibration pick-up devices is included for generating data signals associated with the vibration and acoustic sounds. A plurality of operator activated and controlled sound sensors, e.g. microphones, is also included for capturing operator input, the operator input are then associated with the data signals and integrated into the OBD-II system data stream. Time stamping circuitry is configured for associating a time code with the audio data and converting the audio data into a wav file for storing the audio data as a digital audio data.

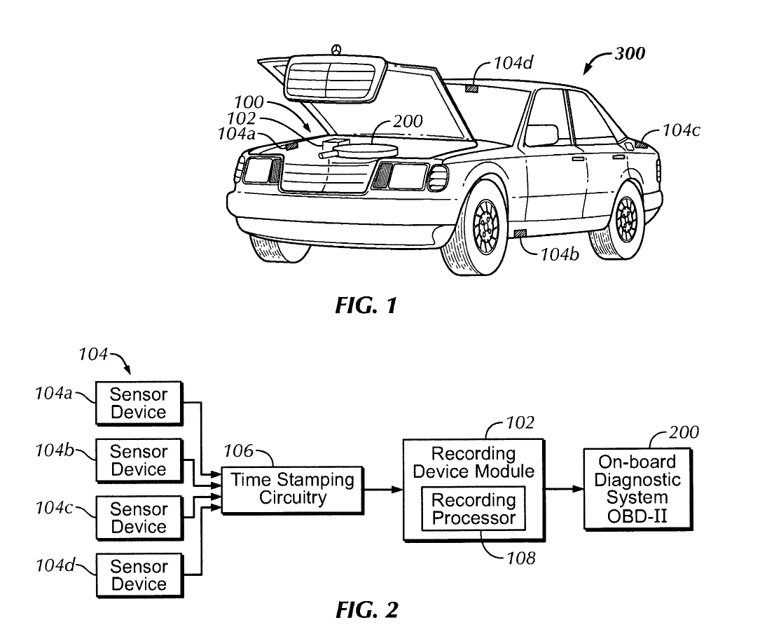

With initial reference to FIG. 1, an on-board automotive audio recorder system in accordance with the present disclosure is illustrated and is designated generally as on-board automotive audio recorder system 100. As illustrated by the figure, automotive audio recorder system 100 is mounted to a vehicle 300 and operably coupled to an OBD-II system (On-Board Diagnostics System, Generation 2) 200 of vehicle 300. OBD-II system, as used herein, encompasses any on-board diagnostic apparatus or system generating a serial data stream consisting of data parameters and diagnostic trouble codes as part of the diagnostic system. Alternatively, an OBD-II system used herein may encompass any on-board diagnostic apparatus or system which provides for self-diagnostic and reporting capability of a vehicle.

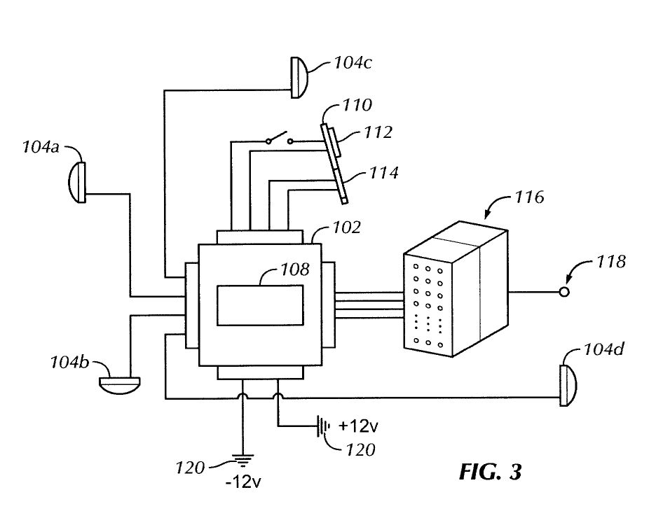

With reference to FIGS. 1 and 2, automotive audio recorder system 100 generally includes a recording device module 102 and a plurality of sensor devices 104 having sensors 104a, 104b, 104c and 104d selectively disposed in proximity to at least one vehicle component; time stamping circuitry 106 for associating a time code with the data signals is also included. The at least one vehicle component may include, for example, the engine compartment, the passenger compartment and the trunk compartment.

In one embodiment, sensor devices 104 are configured for detecting at least one of a vibratory and acoustic sound associated with at least one vehicle component and/or device, where the vibratory and acoustic sounds are undetected by OBD-II system 200. Alternatively, sensor devices 104 are for detecting electrical signals generated by vehicle components and undetected by OBD-II system 200. Sensor devices 104 are further configured for converting the vibratory and acoustic sounds into electromagnetic data signals. In one embodiment, sensor devices 104 are acoustic vibration pick-up devices, however, other sensor devices are also envisioned, such as, for example, electromagnetic sensors, mechanical sensors, chemical sensors, thermal sensors, optical sensor, radiation sensors, and the like.

Time stamping circuitry 106 includes software applications for associating a time code with the vibratory and/or acoustic sounds detected by sensor devices 104a, 104b, 104c and 104d. In one embodiment, the time code includes a calendar date and time. At least one time-stamped electrical data signals is generated and associated with the data signal. The time-stamped electrical data signals are then transmitted to recording device module 102. In one embodiment, time stamping circuitry 106 is a corresponding module of recording device module 102. Alternatively, time stamping circuitry 106 may be a separate module coupled to recording device 102.

Recording device module 102 is adapted for receiving the at least one time-stamped electrical data signals from time stamping circuitry 106. In particular, recording device module 102 is configured for generating and storing a digitized audio data associated with the time-stamped electrical data signal. In one embodiment, recording device module 102 includes a recording processor 108 configured for executing application software for integrating the digitized audio data file and/or operational data into OBD-II system 200. Alternatively, recording processor 108 may be implemented as a separate component coupled to recording device module 102.

In an alternative embodiment, recording processor 108 is coupled to OBD-II system 200 and recording processor 108 includes a recording module for analyzing data signals corresponding to sensor devices 104, generating a digital recording in accordance with the analysis and transmitting the digital recording into the diagnostic data stream of OBD-II system 200. Recording processor 108 further includes a recording notification module for generating and transmitting to OBD-II system 200 a notification message specifying a time code corresponding to the digital recording.

In operation, sensor devices 102 identifies signals undetected by OBD-II system 200, such as, for example, vibratory and/or acoustic signals associated with the malfunction of at least one vehicle component. Time stamping circuitry 106 time stamps the identified signals and transmits the time-stamped signals to recording device module 102. Recording device module 102 generates and stores a digitized audio data associated with the time-stamped electrical data signals. Finally, recording processor 108 executes application software and integrates the digitized audio data file into the serial data stream of OBD-II system 200.

With reference to FIG. 3 in conjunction with FIG. 2, recording device module 102 of on-board automotive recorder system 100 will now be described in detail. As described in great detail hereinabove, sensor devices 104a, 104b, 104c and 104d are coupled to recording device module 102. In addition, recording processor 108 may be formed as an integral component of recording device module 102. Moreover, time stamping circuitry 106 (FIG. 2) may be part of recording processor 108. In one embodiment, an activation control panel 110 is included for effecting actuation of recording device module 102. Activation control panel 110 is coupled to recording device module 102 for transmitting operator input into recording device module 102. The operator input is received by recording device module 102, is time stamped and may be associated with data signals received from sensor devices 104a, 104b, 104c and 104d.

In one embodiment, activation control panel 110 includes an on-off switch 114 and an LED display 112. On-off switch 114 is triggered for manually effecting actuation of recording device module 102. In one embodiment, LED 112 may be coupled to a malfunction indicator lamp (MIL) of OBD-II system 200, such that when MIL is illuminated (e.g. when a malfunction is detected), LED 112 is also illuminated. In operation, when a user notices, for example, an unusual sounds, the operator may manually begin data capture of audio recording, by describing environmental conditions, such as, for example, position of the steering wheel, weather conditions, the time of day, etc.

In another embodiment, audio recording system 100 is automatically actuated upon the detection of a vibratory or acoustic sounds generated by faulty and improperly functioning components and undetected by OBD-II system 200. In this particular embodiment, LED display 116 may be illuminated to indicate to the operator that recording device module 102 is recording. Alternatively, a notification module (not shown) may be included for generating and transmitting a notification message to the operator. The notification message may include, for example, an indicator light, an audible beep and an instant message. In such instance, the operator may choose to manually activate a plurality of sound sensors, such as, for example, a microphones (not shown), selectively disposed and adapted for capturing operator input. The operator, for example, may describe environmental conditions such as time of the day, weather conditions, position of steering wheel, time of the day, etc. The operator input are associated with the data signals and integrated into the data stream of OBD-II system 200.

With continued reference to FIG. 3, recording device module 102 further includes a jumper connector 116 for interfacing recording device module 102 with existing wiring harness 118 to OBD-II system 200. A power input source 120 may be included for powering recording device module 102.

Recording device module 102 may further include circuitry for automatically detecting operational and environmental conditions associated with the data signals generated by the sensor devices 104a, 104b, 104c and 104c. In particular, a system control module (not show) may be interfaced with recording processor 108 such that when audio recording system 100 is activated, operational and environmental conditions are also recorded and associated with the data signals. Generally, the operational and environmental conditions include a plurality of time varying characteristics. These time varying characteristics include, for example, water temperature, brake fluid pressure, oil pressure, efficiency of engine, and a combination thereof.

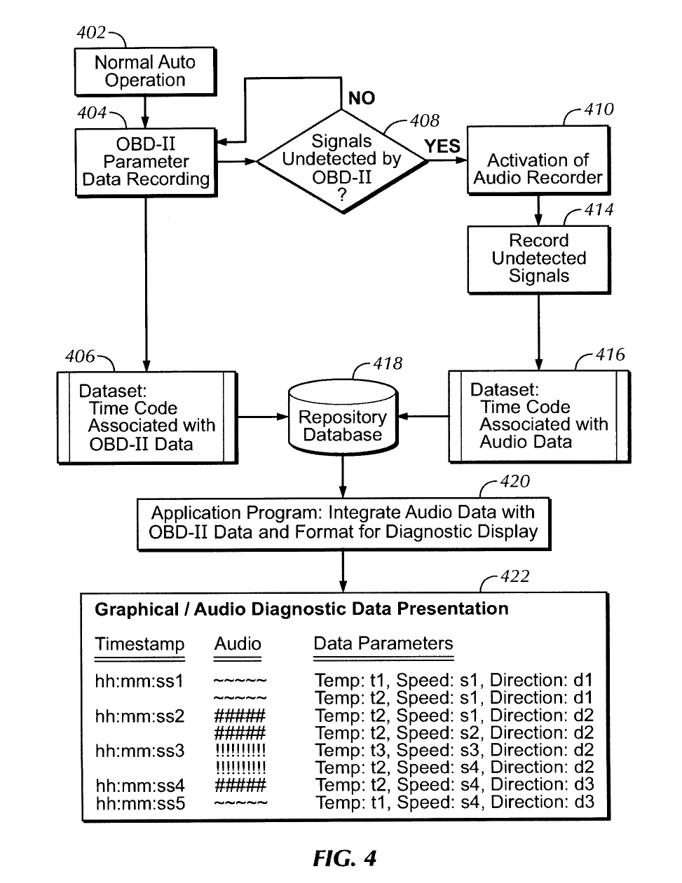

With reference to FIG. 4, a method of operation of the on-board automotive audio recording system 100 for detecting and recording signals undetected by an OBD-II system 200 and transmitting and integrating said undetected signals into the OBD-II system 200 will now be described in detail. During normal automobile operation (402), OBD-II system 200 generates and stores a serial data stream consisting of a plurality of data parameters and diagnostic trouble codes as part of the diagnostic system (404), as known in the art. A time stamp may be associated with the data parameters and diagnostic trouble codes (406). When sensor devices 104 detect a plurality of signals, automotive audio recorder system 100 will be actuated if at least one signal is undetected by OBD-II system 200 (408). If the plurality of signals is detected by OBD-II system 200, then the plurality of signals is stored as described hereinabove with respect to step (404). Recording device module 102 is activated (410) when at least one signal is undetected by OBD-II system 200. LED display 112 may be illuminated for alerting an operator that recording device module 102 has been actuated, as described in detail hereinabove. Thus the operator may manually activate recording device module 102 for describing, for example, environmental conditions. As such, recording device module 102 begins generating and recording a digitized audio data associated with the undetected signals (414). A time code is generated and associated with the audio data recorded by recording device module 102 (416).

The time-stamped audio data from recording device module 102 (416) and the data parameters and diagnostic trouble codes (406) recorded by OBD-II system 200 are collected in a repository database (418). Recording processor 108 then executes application software for formatting this information for diagnostic display (420). The diagnostic display is then integrated into OBD-II system 200. The diagnostic display includes a graphical/audio diagnostic data presentation (422), wherein the audio data can be played audibly and/or represented graphically.

The following example illustrates the method of detecting signals undetected by an OBD-II system in accordance with the present disclosure. It is noted that the following example is not intended to limit the disclosure, but is included for illustrative purpose.

### EXAMPLE 1

An operator is traveling north east at 60 miles per hour at 11:30 PM on a raining night. The operator notices an unusual sound coming from the direction of the engine. In addition, LED display 116 is illuminated indicating that recording device module 102 has been actuated and signals undetected by OBD-II system 200 are being recorded therein. The operator triggers on/off switch 112 of operator panel 110 for actuating recording device module 102 and describing the environmental conditions. The operator proceeds to describe the environmental conditions in real time, e.g. it is 11:30 PM, raining, traveling north east, position of steering wheel is 2 o'clock, etc. The operator input are integrated with the undetected data signals, are recorded by recording device module 102 and integrated into OBD-II system 200 for aiding repair technicians.

It will be understood that numerous modifications and changes in form and detail may be made to the embodiments of the present disclosure. It is contemplated that numerous other configuration of the on-board automotive audio recorder system 100 may be used, and the components of the on-board automotive audio recorder system 100 may be selected from numerous components other than those specifically disclosed. Therefore, the above description should not be construed as limiting the disclosed on-board automotive audio recorder system and method 100, but merely as exemplification of the various embodiments thereof. Those skilled in the art will envisioned numerous modifications within the scope of the present disclosure as defined by the claims appended hereto. In short, it is Applicant's intention that the scope of the patent issuing herefrom will be limited only by the scope of the appended claims. Having thus complied with the details and particularity required by the patent laws, what is claimed and desired protected is set forth in the appended claims.

What is claimed is:

1. A recording system coupled to an on-board diagnostic system, the recording system comprising:
at least one sensor device for detecting at least one of a vibratory and acoustic signals, said at least one of a vibratory and acoustic signals being undetected by said on-board diagnostic system;
a recording device module for generating and storing an audio data associated with said undetected signals; and
at least one processor coupled to the recording device module, wherein the at least one processor is configured for executing application software for integrating said audio data into said on-board diagnostic system.

2. The recording system as recited in claim 1, further comprising time stamping circuitry operably connected to said recording device module and being configured for associating a time code with said undetected signals for generating at least one time-stamped data signals.

3. The recording system as recited in claim 1, further comprising an activation control panel coupled to said recording device module for effecting actuation of said recording device module.

4. The recording system as recited in claim 3, wherein said activation control panel is adapted for receiving operator input and further wherein said operator input is associated with said undetected signals.

5. The recording system as recited in claim 1, wherein said at least one sensor device is selectively in proximity to an vehicle component.

6. The recording system as recited in claim 5, wherein said vehicle component is selected from a group consisting of an engine compartment, passenger compartment, trunk compartment, and a combination thereof.

7. The recording system as recited in claim 1, wherein said at least one sensor device is an acoustic vibration pick-up device.

8. The recording system as recited in claim 1, wherein said at least one sensor device is selected from a group consisting of an acoustic sensors, electromagnetic sensors, mechanical sensors, chemical sensors, thermal sensors, optical sensors and radiation sensors and a combination thereof.

9. The recording system as recited in claim 1, wherein said at least one processor further comprises a notification module for generating and transmitting a notification message to an operator.

10. The recording system as recited in 9 wherein the notification message is selected from the group consisting of indicator lights, audible beep, instant message and a combination thereof.

11. A system comprising:
at least one sensor device for sensing at least one signal undetected by an on-board diagnostic system;
a recording device module having time stamping circuitry for associating a time code with said undetected signal for generating time-stamped data signals, wherein said recording device module is configured for recording said time-stamped data signals; and
at least one processor interfaced to said recording device module, wherein said at least one processor is configured for executing application software for integrating said data file into said on-board diagnostic system.

12. The recording system as recited in claim 11, further comprising an activation control panel coupled to said recording device module for effecting actuation of said recording device module.

13. The recording system as recited in claim 12, wherein said activation control panel is adapted for receiving operator input and further wherein said operator input is associated with said undetected signals.

14. The recording system as recited in claim 11, wherein said at least one sensor device is selectively in proximity to a vehicle component.

15. The recording system as recited in claim 14, wherein said vehicle component is selected from a group consisting of an engine compartment, passenger compartment, trunk compartment, and a combination thereof.

16. The recording system as recited in claim 11, wherein said at least one sensor device is an acoustic vibration pick-up device.

17. The recording system as recited in claim 11, wherein said at least one signal include at least one of a vibratory and acoustic signal.

18. The recording system as recited in claim 11, wherein said at least one processor further comprises a notification module for generating and transmitting a notification message to an operator, wherein said notification message is selected from the group consisting of indicator lights, audible beep, instant message and a combination thereof.

19. A method for integrating signals into an on-board diagnostic system, the method comprising:
detecting signals undetected by said on-board diagnostic system;
recording said undetected signals; and
integrating said recorded signals into said on-board diagnostic system.

20. The method for integrating signals according to claim 19, further comprising generating a time code associated with said recorded signals for time stamping said recorded signals.

21. The method for integrating signals according to claim 19, wherein said undetected signals are associated with at least one of a vibratory and acoustic sound.

22. A method for integrating audio data into an on-board diagnostic system, the method comprising:
generating and transmitting signals associated with vibratory and acoustic sounds, wherein said signals are undetected by said on-board diagnostic system;
time stamping said signals for associating a time code with said signals;
generating and recording an audio data associated with said time-stamped signals; and
transferring said audio data into a serial data stream of said on-board diagnostic system.

23. The method for integrating audio data according to claim 22, further comprising receiving operator input, wherein said operator input is associated with said undetected signals.

24. The method for integrating audio data according to claim 22, further comprising combining data stream associated with said on-board diagnostic system and said digitized audio data for diagnostic display.
